(19) United States
(12) Patent Application Publication
(10) Pub. No.: US 2019/0106292 A1
(43) Pub. Date: Apr. 11, 2019

(54) GUIDE ARRANGEMENT FOR AN ELEVATOR SYSTEM

(71) Applicants: thyssenkrupp Elevator AG, Essen (DE); thyssenkrupp AG, Essen (DE)

(72) Inventor: Holger ZERELLES, Leinfelden-Echterdingen (DE)

(73) Assignees: thyssenkrupp Elevator AG, Essen (DE); thyssenkrupp AG, Essen (DE)

(21) Appl. No.: 16/088,313

(22) PCT Filed: Mar. 30, 2017
(86) PCT No.: PCT/EP2017/057551

§ 371 Date: Sep. 25, 2018

(30) Foreign Application Priority Data
Apr. 1, 2016 (DE) 10 2016 205 463.5

(51) Int. Cl. B66B 7/04

(52) U.S. Cl. CPC B66B 7/046; B66B 7/044; B66B 7/042

(57) ABSTRACT

An elevator system may include a guide rail and a car that is movable along the guide rail in a driving direction. A first guide element may be connected to the car. Furthermore, the guide rail may comprise a first guide section that has a first guide groove. The first guide element may engage positively in the first guide groove, and the first guide element may be guided in the first guide groove as the car moves. The elevator system may also include a second guide element that is connected to the car and is disposed adjacent to the first guide element. The second guide element may also engage positively in the first guide groove and be guided in the first guide groove as the car moves.”

The invention relates to an elevator system having a car, which is guided along a guide rail. Elevator systems are used for the conveyance of passengers between different floors of a building. For this purpose, a car is moved between the floors inside an elevator shaft. Conventionally, the car is connected to a counterweight for this purpose via a suspension cable, wherein the cable runs over a driven sheave. On the other hand, alternative elevator systems no longer use any counterweights and are driven by means of linear motors, which are integrated in the rails and cars. Suchlike elevator systems, which are equipped with a linear motor, are familiar from EP1507329 or EP1818305, for example. Since a suspension cable is dispensed with in suchlike elevator systems, both the drive and the brake engage on the guide rails of the car. It is therefore necessary to ensure that the car is guided securely along the guide rails. Derailing could result in both the drive and the brake no longer being able to function. This could result in the car falling.

The object of the present invention is therefore to improve the elevator system in such a way that derailing of the car can be reliably prevented.

This object is addressed by an elevator system comprising a guide rail and a car, which can be moved along the guide rail in a driving direction, wherein a first guide element is connected to the car. In this context, the guide rail comprises a first guide section having a first guide groove, in which the first guide element engages positively and in which the first guide element is guided as the car moves. Guiding of the first guide element in a first guide groove provides additional security for the position of the car. The width of the first guide groove thus defines a maximum clearance for the first guide element. If the first guide element deviates too far from its nominal position, it will come into contact with the lateral edge of the guide groove, which prevents further deviation. In this way, the width of the guide groove defines a maximum deviation from the nominal position. The guide groove in this case extends parallel to the driving direction.

In a further development of the embodiment, the elevator system comprises a second guide element, which is arranged closely adjacent to the first guide element and is connected to the car, wherein the second guide element likewise engages positively in the first guide groove and is guided in the first guide groove as the car moves. This has the additional advantage that, even in the event of failure, in particular loss, of the first guide element, secure guiding of the car along the guide rail is facilitated. The guiding is also designed with redundancy, in order to prevent derailing in any event.

The expression adjacent in this context is intended to denote in particular that the two guide elements are arranged at the same height in relation to the driving direction. However, it is also possible to provide an offset in the direction of the driving direction between the two guide elements.

The first guide element in this case is typically embodied as a guide roller, which is in contact with the guide rail as the car moves. Guide rollers allow secure guiding with simultaneous low wear during operation. As an alternative, the first guide element can also be embodied as a sliding shoe, which is in contact with the guide rail as the car moves. Unlike guide rollers, which roll along the guide rail as the car moves, the sliding shoe slides along the guide rail.

The second guide element is embodied in a variant of the invention as an emergency stop, which exhibits a distance to the guide rail as the car moves during normal operating mode. In the event of failure, in particular loss, of the first guide element, the emergency stop comes into contact with the guide rail and in this way secures the car against derailing.

The invention thus also relates to a method for securing a car of an elevator system in the event of the loss of a guide roller. The elevator system in this case comprises a guide rail and a car, which can be moved along the guide rail, wherein the guide roller rolls along the guide rail as the car moves. In this case, a second guide element is connected to the car and engages positively in a first guide groove, which is arranged in a first guide section on the guide rail. As the car moves, the second guide element is guided in the first guide groove, so that, in the event of loss of the guide roller, the car is secured against derailing by the second guide element in the first guide groove. In this case, the guide roller itself is thus not necessarily guided in a guide groove, but only the second guide element where appropriate. Typically, the second guide element in this case is embodied as an emergency stop, which exhibits a distance to the guide rail as the car moves during normal operating mode. In this case, too, in the event of failure, in particular loss, the emergency stop of the guide roller comes into contact with the guide rail and secures the car against derailing in this way.

In particular, the invention also relates to a method for securing a car of an elevator system in the event of the loss of a guide roller, in which the elevator system comprises a guide rail and a car which can be moved along the guide rail. The elevator system in this case also comprises a first guide element and a second guide element, both of which are connected to the car. In a first operating state of the elevator system, the first guide element is in contact with the guide rail, whereas the second guide element is at a distance from the guide rail. This is the normal operating mode of the elevator system. In a second operating state (emergency operation), in which the first guide element has failed, the second guide element is in contact with the guide rail. In the second operating state, the second guide element thus secures the car in order to prevent derailing. Here, too, the second guide element is preferably guided by a guide groove for this purpose. In this operating state, the elevator system cannot continue to be operated during normal operating mode, although it is at least possible to move the car along the guide rail to an evacuation floor without having any reason to fear derailing of the car.

Both the elevator system described above and the two aforementioned methods can be improved in particular in that the first guide section comprises a second guide groove, wherein the first guide groove and the second guide groove are arranged on opposite sides of the first guide section, so that a T-shaped cross-section of the first guide sections arises in areas. Furthermore, the car is connected to a third guide element, which engages positively in the second guide groove and is guided in the second guide groove as the car moves. The first guide element and the third guide element are thus in contact with the guide rail on opposite sides of the first guide section and receive the first guide section between them. On the one hand, this embodiment facilitates secure and stable guiding, since the pressing forces of the first guide element and of the third guide element act in the opposite direction. On the other hand, it has the advantage that both guide elements (the first guide element and the third guide element) are guided in their own guide groove (first guide groove or second guide groove), so that particularly secure guiding is obtained.

Most preferably, furthermore, the elevator system comprises a fourth guide element, which is arranged closely adjacent to the third element and is connected to the car. In this case, the fourth guide element engages positively in the second guide groove and is guided in the second guide groove as the car moves. This has the additional advantage that secure guiding of the car along the guide rail is facilitated, even in the event of failure, in particular loss, of the third guide element. The guiding is also designed with redundancy, in order to prevent derailing in any event.

In particular the third guide element is executed as a guide roller, and the fourth guide element is accordingly executed as an emergency stop—similar to the embodiment of the first guide element and of the second guide element.

In an improved variant of the elevator system, the guide rail comprises a second guide section having a third guide groove. At the same time, the car is connected to a fifth guide element, which engages positively in the third guide groove and is guided in the third guide groove as the car moves. The stability of the entire guide arrangement is further increased as a result.

As mentioned by way of introduction, the inventive embodiment of the guide arrangement is particularly relevant for an elevator system, which comprises a linear drive for moving the car along the guide rail. In suchlike elevator systems, the drive is typically integrated at least partially in the guide rail, so that uncontrolled derailing can lead to failure of the drive. It is particularly important, therefore, for the car to remain in the guide. Furthermore, the car in suchlike elevator systems typically comprises a brake mechanism, which engages on the guide rail. This is a further reason why derailing of the car must be avoided in any event.

The invention is described in more detail below with the aid of drawings. Specifically:

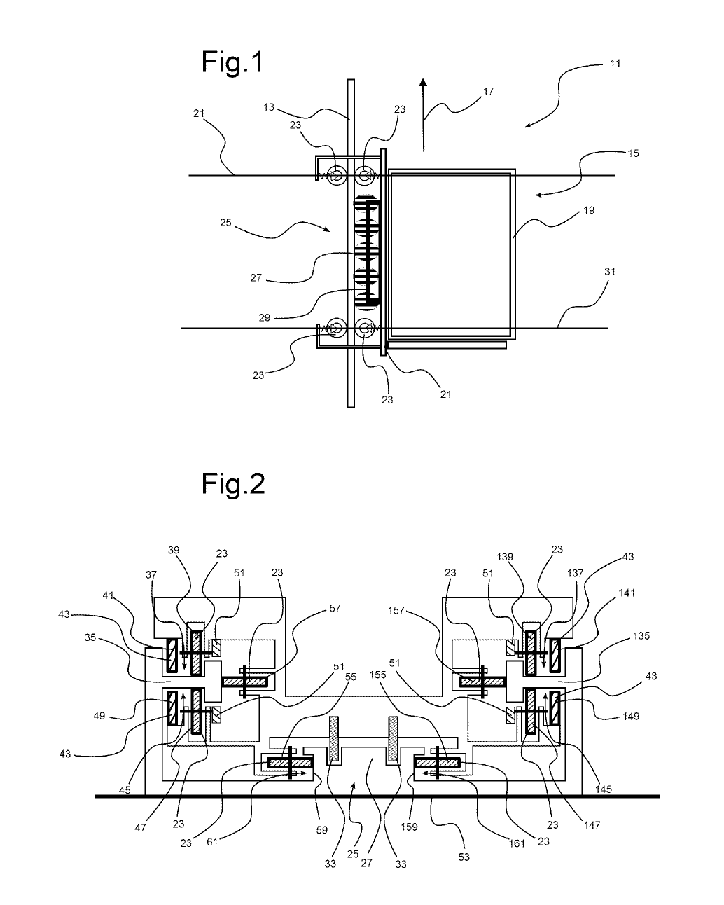

FIG. 1 depicts a schematic representation of the elevator system;

FIG. 2 depicts a section through the supporting frame and the guide rail in the first operating state;

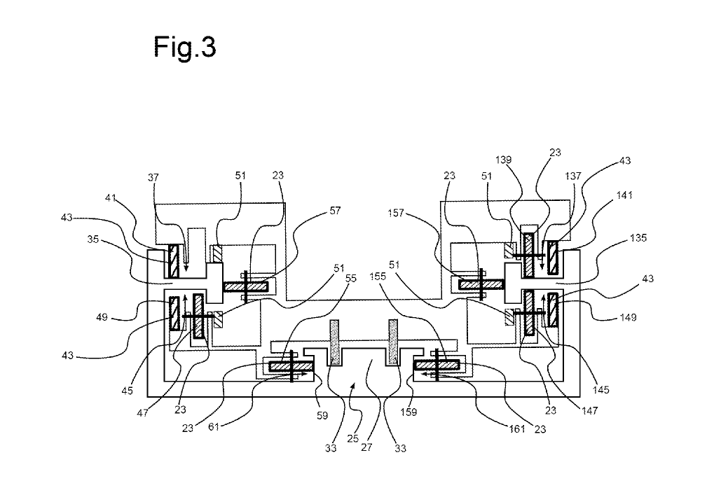

FIG. 3 depicts the same section in the second operating state.

FIG. 1 depicts a schematic representation of an elevator system 11. The elevator system 11 comprises a guide rail 13 and a car 15. The car is capable of moving in a driving direction 17 along the guide rail 13. The car 15 comprises an elevator cabin 19 and a supporting frame 21. The elevator system 11 is embodied as a so-called rucksack configuration. The guide rail in this case 13 is arranged on only one side of the car 15. Guide rollers 23, which roll along the guide rail 13 as the car 15 moves, are arranged on the supporting frame 21 of the car 15.

The car 15 is driven by means of a linear motor 25. The linear motor 25 comprises a stationary component 27, which extends along the guide rail 13, and a mobile component 29, which is connected to the car 15.

FIG. 2 depicts a section through the supporting frame 21 and the guide rail 13 along the section line 31 illustrated in FIG. 1 in the lower region of the car 15. A section along the section line 32 in the upper region of the car 15 is of analogous appearance, since the lower guiding and the upper guiding are of identical embodiment. The guide rail 13 has a substantially U-shaped form having different regions, in which the guide elements of the car engage. The linear motor 25 is arranged in a central region of the guide rail 13. The linear motor 25 comprises a mobile component 29, which contains two permanent magnets 33. These form the secondary part of the linear motor 25. A part of the guide rail 13 is the stationary component 27 of the linear motor 25, which is embodied as a primary part, which at least partially encloses the two permanent magnets 23.

Furthermore, the guide rail 13 comprises a first guide section 35 having a first guide groove 37. A first guide element 39 engages positively in the first guide groove 37. The first guide element 39 is connected to the supporting frame 21 and thus to the car 15. The first guide groove 37 extends parallel to the driving direction 17. As the car 15 moves, the first guide element 39 is thus guided in the first guide groove 37. The positive engagement of the first guide element 39 in the first guide groove 37 secures the car 15 against derailing from the guide rail 13. In the represented first operating state, which represents the normal operating mode of the elevator system, the first guide element 39 is in contact with the guide rail 13. In the depicted embodiment, the first guide element 39 is embodied in the form of a guide roller 23. As the car 15 moves, the first guide element 39 thus rolls along the guide rail 13.

A second guide element 41 is arranged closely adjacent to the first guide element 39 and is also connected to the supporting frame 21 and thus to the car 15. The second guide element 41 also engages positively in the first guide groove 37 and is guided in the first guide groove 37 as the car 15 moves. In the depicted first operating state, the second guide element 41 is at a distance from the guide rail 13. The second guide element 41 is embodied as an emergency stop 43. In the event of failure of the first guide element 39, the second guide element 41 assumes the security of the car 15 and thus prevents derailing of the car 15. This is explained in detail with reference to FIG. 3.

The first guide section 35 further comprises a second guide groove 45, wherein the first guide groove 37 and the second guide groove 45 are arranged on opposite sides of the first guide section 35, so that a T-shaped cross-section of the first guide section 35 arises in areas. A third guide element 47 engages positively in the second guide groove 45, which is connected to the supporting frame 21 and thus to the car 15. As the car 15 moves, the third guide element 47 is guided in the second guide groove 45. In the present case, the third guide element 47 is embodied as a guide roller 23, which is in contact with the guide rail 13 as the car 15 moves and rolls on the guide rail 13. A fourth guide element 49 is arranged closely adjacent to the third guide element 47 and is connected to the supporting frame 21 and thus to the car 15. The fourth guide element 49 also engages positively in the second guide groove 45 and is guided in the second guide groove 45 as the car 15 moves. In the depicted first operating state, the fourth guide element 49 is at a distance from the guide rail 13. The fourth guide element 49 is embodied as an emergency stop 43, in order to assume the securing of the car 15 in the second guide groove 45 in the event of failure of the third guide element 47.

A brake mechanism 51 is connected to the supporting frame 21, furthermore, in order to decelerate the car 15. In the represented embodiment, the brake mechanism 51 engages on opposite sides of the first guide section 35.

The first guide element 39 and the third guide element 47 are in contact with the guide rail 13 on opposite sides of the first guide section 35 and receive the first guide section 35 between them. The first guide element 39 and the third guide element 47 are embodied in each case as guide rollers 23, wherein the axes of rotation run parallel to one another. This arrangement of the axes of rotation running parallel to one another with the first guide section 35 between the opposing guide rollers determines the position of the car 15 in a direction perpendicular to the axes of rotation and perpendicular to the driving direction. This means that the distance of the car 15 to the shaft wall 53, on which the guide rail 13 is positioned, is fixed as a result. A fifth guide element 55 and a sixth guide element 57 are envisaged in order to determine the position of the car 15 in the still missing transverse direction (perpendicular to the driving direction 17). For this purpose, the guide rail 13 comprises a second guide section 59 having a third guide groove 61, in which the fifth guide element 55 engages positively and in which the fifth guide element 55 is guided as the car 15 moves. The fifth guide element 55 is embodied as a guide roller 23, of which the axis of rotation runs perpendicular to the axes of rotation of the first guide element 39 and of the second guide element 47 and perpendicular to the driving direction 17. The sixth guide element 57 is also embodied as a guide roller 23 and is in contact with the guide rail 13 of the first guide section 35. The axis of rotation of the sixth guide element 57 runs parallel to the axis of rotation of the fifth guide element 55. In the depicted embodiment, the sixth guide element 57 does not engage in a guide groove. As an alternative, however, a corresponding guide groove for guiding the sixth guide element 57 as the car 15 moves can also be envisaged at this point.

The previous explanation concerned only the region of the guide rail 13 and the supporting frames 21 represented on the left in FIG. 2. In order, on the one hand, to distribute the forces more evenly over the rear of the car 15 and, on the other hand, to design the entire guiding mechanism with redundancy, the design is of similar embodiment in the region represented on the right. In the present case, the design on the right is even embodied as a mirror image in relation to the design embodied on the left. The design is explained briefly below in the right-hand region, wherein mirror-inverted components are given a reference designation increased by 100. For the detailed description, reference is made in this respect to the preceding sections in respect of the region represented on the left.

The guide rail 13 has a third guide section 135 having a fourth guide groove 137. A seventh guide element 139 engages positively in the fourth guide groove 137. The seventh guide element 139 is connected to the supporting frame 21 and thereby to the car 15. The fourth guide groove 137 extends parallel to the driving direction 17. As the car 15 moves, the seventh guide element 139 is guided in the fourth guide groove 137 in the process. In the depicted embodiment, the seventh guide element 139 is embodied in the form of a guide roller 23. As the car 15 moves, the seventh guide element 139 thus rolls along the guide rail 13.

An eighth guide element 141 is arranged closely adjacent to the seventh guide element 139 and is also connected to the supporting frame 21 and thus to the car 15. The eighth guide element 141 also engages positively in the fourth guide groove 137 and is guided in the fourth guide groove 137 as the car 15 moves. In the depicted first operating state, the eighth guide element 141 is at a distance from the guide rail 13. The eighth guide element 141 is embodied as an emergency stop 43.

The third guide section 135 furthermore comprises a fifth guide groove 145, wherein the fourth guide groove 137 and the fifth guide groove 145 are arranged on opposite sides of the third guide section 135, so that a T-shaped cross-section of the third guide section 135 arises in areas. A ninth guide element 147 engages positively in the fifth guide groove 145, which is connected to the supporting frame 21 and thus to the car 15. The ninth guide element 147 is guided in the fifth guide groove 145 as the car 15 moves. In the present case, the ninth guide element 147 is embodied as a guide roller 23, which is in contact with the guide rail 13 as the car 15 moves and rolls on the guide rail 13. A tenth guide element 149 is arranged closely adjacent to the ninth guide element 147 and is connected to the supporting frame 21 and thus to the car 15. The tenth guide element 149 also engages positively in the fifth guide groove 145 and is guided in the fifth guide groove 145 as the car 15 moves. In the depicted first operating state, the tenth guide element 149 is at a distance from the guide rail 13. The tenth guide element 149 is embodied as an emergency stop 43, in order to assume the securing of the car 15 in the fifth guide groove in the event of a failure of the ninth guide element 147.

Also present in the region represented on the right is a brake mechanism 51, which is connected to the supporting frame 21 and engages correspondingly on opposite sides of the third guide section 135.

The guide rail 13 furthermore comprises a fourth guide section 159 having a sixth guide groove 161, in which the eleventh guide element 155 engages positively, in which the eleventh guide element 155 is guided as the car 15 moves. The eleventh guide element 155 is embodied as a guide roller 23. A twelfth guide element 157 is provided, furthermore, which is also embodied as a guide roller 23 and which is in contact with the guide rail 13 in the third guide section 135.

FIG. 3 depicts a second operating state, in which the first guide element 39 has failed, and in particular is no longer present. In this second operating state, the second guide element 41 ensures secure guiding of the car 15 in the first guide groove 37. Since the first guide element 39 is absent, the supporting frame 21 is tilted in relation to the guide rail 13, and the second guide element 41, which is embodied as an emergency stop 43, is in contact with the guide rail 13 in the first guide section 35. Of course, the normal operating mode of the elevator system is no longer possible in this operating state. However, the second guide element 41, which engages positively in the first guide groove 37, ensures that derailing of the car 15 is reliably prevented. The car 15 can thus be moved at least to an evacuation floor, without compromising the safety of the passengers in the car 15. The same also applies for the loss of one of the other guide elements 47, 139 or 147.

### LIST OF REFERENCE DESIGNATIONS

elevator system 11

guide rail 13

car 15

driving direction 17

elevator cabin 19

supporting frame 21

guide rollers 23

linear motor 25

stationary component 27

mobile component 29

first section line 31

second section line 32

permanent magnet 33

first guide section 35

first guide groove 37

first guide element 39

second guide element 41

emergency stop 43

second guide groove 45

third guide element 47

fourth guide element 49

brake mechanism 51

shaft wall 53

fifth guide element 55

sixth guide element 57

second guide section 59

third guide groove 61

third guide section 135

fourth guide groove 137

seventh guide element 139

eighth guide element 141

fifth guide groove 145

ninth guide element 147

tenth guide element 149

eleventh guide element 155

twelfth guide element 157

fourth guide section 159

sixth guide groove 161

1-12. (canceled)

13. An elevator system comprising:
a guide rail that includes a first guide section having a first guide groove;
a car that is movable along the guide rail in a driving direction; and
a first guide element connected to the car, wherein the first guide element engages positively in the first guide groove and is guided in the first guide groove as the car moves.

14. The elevator system of claim 13 comprising a second guide element that is disposed adjacent to the first guide element and is connected to the car, wherein the second guide element engages positively in the first guide groove and is guided in the first guide groove as the car moves.

15. The elevator system of claim 14 wherein the first guide section of the guide rail comprises a second guide groove, wherein the first and second guide grooves are disposed on opposite sides of the first guide section such that at least a portion of the first guide section has a T-shaped cross-section, wherein the car is connected to a third guide element that engages positively in the second guide groove and is guided in the second guide groove as the car moves.

16. The elevator system of claim 15 wherein at least one of the first guide element or the third guide element is a guide roller that is in contact with the guide rail as the car moves.

17. The elevator system of claim 15 wherein at least one of the first guide element or the third guide element is a sliding shoe that is in contact with the guide rail as the car moves.

18. The elevator system of claim 15 wherein the guide rail comprises a second guide section that has a third guide groove, wherein the car is connected to the fifth guide element, wherein the fifth guide element engages positively in the third guide groove and is guided in the third guide groove as the car moves.

19. The elevator system of claim 15 comprising a fourth guide element that is disposed adjacent to the third guide element and is connected to the car, wherein the fourth guide element engages positively in the second guide groove and is guided in the second guide groove as the car moves.

20. The elevator system of claim 19 wherein at least one of the second guide element or the fourth guide element is an emergency stop that is spaced apart from the guide rail as the car moves.

21. The elevator system of claim 13 wherein the car includes a brake mechanism that engages on the guide rail.

22. A method for securing a car of an elevator system in case of a loss of a guide roller, wherein the elevator system comprises a guide rail and a car that is movable along the guide rail, wherein a guide element is connected to the car, wherein the guide rail comprises a first guide section having a first guide groove, the method comprising:
rolling the guide roller along the guide roll while the car is moving; and
positively engaging and guiding the guide element in the first guide groove while the car is moving such that the car is secured against derailment by the guide element in the first guide groove in case of the loss of the guide roller.

23. The method of claim 22 wherein the guide element is an emergency stop that is spaced apart from the guide rail as the car moves.

24. A method for securing a car of an elevator system in case of a loss of a guide roller, wherein the elevator system comprises a guide rail and a car that is movable along the guide rail, wherein a first guide element and a second guide element are connected to the car, the method comprising:
in a first operating state, positioning the first guide element to be in contact with the guide rail and positioning the second guide element to be spaced apart from the guide rail; and
in a second operating state in which the first guide element has failed, positioning the second guide element to be in contact with the guide rail.
